(19) United States
(12) Patent Application Publication
(10) Pub. No.: US 2021/0124357 A1
(43) Pub. Date: Apr. 29, 2021

(54) MOVABLE MACHINE

(71) Applicant: SICK AG, Waldkirch (DE)

(72) Inventor: Mathias AMS, Waldkirch (DE)

(21) Appl. No.: 17/070,147

(22) Filed: Oct. 14, 2020

(30) Foreign Application Priority Data
Oct. 24, 2019 (DE) 102019128782.0

(51) Int. Cl. G05D 1/02; G01S 17/894

(52) U.S. Cl. CPC G05D 1/0214; G05D 1/0274; G05D 1/0272; G05D 1/0088; G05D 1/0251; G01S 17/894; G05D 1/0248; G05D 1/0234

(57) ABSTRACT

A movable machine (1) and a method having a safety system (2), having a safety controller (7), having a localization system (3), having a distance sensor (4) for an at least areal monitoring of a monitored zone, and having a contour recognition unit (6), wherein a position (9) of a safe point of interest (8) can be identified by means of the localization system (3) and a contour (10) of the safe point of interest (8) can be identified by means of the distance sensor (4) and the contour recognition unit (6), with a change of the safety function of the safety system (2) taking place by means of the safety controller (7) on an identification of the position (9) of the safe point of interest (8).

The present invention relates to a movable machine the moveable machine comprising a safety system, a safety controller, a localization system, a distance sensor for an at least areal monitoring of a monitored zone, and a contour recognition unit, and to a method having a movable machine.

There is the challenge in applications with movable machines, that is in particular autonomous mobile machines or guideless vehicles, of exactly knowing a position of the movable machine since a switching over of protective devices is, for example, necessary with reference to the position.

The switching over of the protective device is necessary since the functional safety has to be situatively adapted to the demand of the application. A primary protective function, e.g. a detection of a person by means of a safe laser scanner is, for example, unsuitable since this would disrupt the automation application.

An autonomous vehicle, for example, drives through an industrial plant without any track guidance, but rather by means of map navigation. An intrinsically safe laser scanner takes over a primary protective function, i.e. a detection of a person, and then then stops the autonomous vehicle as required. The safety function of the autonomous vehicle has to be adapted at constrictions, transfer points, etc. since there is otherwise the risk of process downtimes.

A standard securing via intrinsically safe laser scanners, for example, does not work when passing through constrictions since the constriction would have the consequence of an interruption of or an intrusion into the protected field of the laser scanner or crush points for persons could be produced with a narrow protected field that would still pass through the constriction.

A standard securing via intrinsically safe laser scanners, for example, does not work when starting from transfer stations since the transfer station would have the consequence of an interruption of or an intrusion into the protected field of the laser scanner.

It is an object of the invention to provide a solution for the above-named applications.

The object is satisfied in accordance with claim 1 by a movable machine having a safety system, having a safety controller, having a localization system, having a distance sensor for an at least areal monitoring of a monitored zone, and having a contour recognition unit, wherein a position of a safe point of interest can be identified by means of the localization system and a contour of the safe point of interest can be identified by means of the distance sensor and the contour recognition unit, with a change of the safety function of the safety system taking place by means of the safety controller on an identification of the position of the safe point of interest of the contour of the safe point of interest.

The object is further satisfied by s method having a movable machine having a safety system, having a safety controller, having a localization system, having a distance sensor for an at least areal monitoring of a monitored zone, and having a contour recognition unit by means of which a position of a safe point of interest can be identified by means of the localization system and a contour of the safe point of interest is identified by means of the distance sensor and the contour recognition unit, with a change of the safety function of the safety system being carried out by means of the safety controller on an identification of the position of the safe point of interest.

The movable machine or mobile machine can, for example be a guideless vehicle, a driverless vehicle or an autonomous vehicle, an automated guided vehicle (AGV), an autonomous mobile robot (AMR), an industrial mobile robot (IMR), or a robot having movable robot arms. The movable machine thus has a drive and can be moved in different directions.

The safe point of interest (SPOI) is a simplified variant of a safe positioning that is restricted to a detection of particular positions in an industrial application at which it is necessary to adapt the safety system or a protective device or a safety function of the movable machine to ensure both personal protection and machine availability. The safe point of interest is a synonymous name for a safe location of interest, that is not a singular point.

The safety system is at least formed by the safety controller, the localization system, the distance sensor, and the contour recognition unit. The contour recognition unit and the localization system are here connected to the safety controller. The distance sensor is at least connected to the contour recognition unit.

The safety controller has inputs, a processing unit, and outputs. The contour recognition unit and the localization system are connected to the inputs. The outputs are connected to functional units such as the drive, the brakes, and/or the steering of the movable machine. The safety controller can be a modular safety controller that is programmable via software.

The localization system can determine a position of the movable machine on a surface or in space. The position determination can, for example, take place locally by means of radio, for example by an ultra-wideband system (UWB). A LIDAR navigation can furthermore be provided for the position determination. Global navigation systems such as a GPS system can also be used.

The distance sensor for the at least areal monitoring of a monitored zone is a sensor for distance measurement. The distance sensor delivers distance values in at least two-dimensional space. In so doing, the sensor outputs measured values with distance indications and angle indications. For example, the distance is determined by means of time of flight methods or triangulation methods.

The contour recognition unit is connected to the distance sensor. The contour recognition unit evaluates a plurality of measured values, in particular distance values or spacing values of the distance sensor to determine a detected contour.

The contour recognition unit converts the distance values into geometrical contour information. They can be linear, areal, or spatial contours or contour data.

The invention is based on the fact that a safe point of interest can be uniquely identified by two mutually independent features. These features are the position and the contour or geometry of the safe point of interest or safe location of interest. The safe point of interest is thus identified by a redundant, in particular diverse, system.

In a further development of the invention, the distance sensor is, for example, a laser scanner, a safety laser scanner, a 3D camera, a stereo camera, or a time of flight camera, or similar.

To avoid collisions and to protect persons, the laser scanner or the safety laser scanner, for example, monitors a protected field that may not be entered by persons during the movement of the movable machine. If the laser scanner recognizes an unauthorized intrusion into the protected field, for instance a leg of a person, the laser scanner triggers an emergency stop of the movable machine. Sensors used in safety engineering have to work particularly reliably and intrinsically safely and must therefore satisfy high safety demands, for example the standard EN13849 for safety of machinery and the machinery standard EN1496 for electrosensitive protective equipment (ESPE).

To satisfy these safety standards, a series of measures have to be taken such as a secure electronic evaluation by redundant and/or diverse electronics or different functional monitoring processes, especially the monitoring of the contamination of optical components, including a front lens. A safety laser scanner in accordance with such standards is known, for example, from DE 43 40 756 A1.

The term “functionally safe” is to be understood in the sense of the standards named or of comparable standards; measures are therefore taken to control errors up to a specified safety level. The safe sensor and/or at least one non-safe sensor moreover generate non-safe data such as raw data, point clouds, or the like. Non-safe is the opposite of safe and accordingly said demands on failsafeness are not satisfied for non-safe devices, transmission paths, evaluations, and the like.

A 3D camera, for example, likewise monitors a monitored zone of the movable machine by means of a plurality of detected distance values. A 3D camera has the advantage that a volume-like protected zone can be monitored.

A stereo camera, for example, likewise monitors a monitored zone of the movable machine by means of a plurality of detected distance values. The distance values are determined on the basis of the two cameras of the stereo camera that are installed at a basic spacing from one another. A stereo camera equally has the advantage that a volume-like protected zone can be monitored.

Distance values that are determined by an image sensor are determined by means of a time of flight camera on the basis of the measured time of flight. A time of flight camera equally has the advantage that a volume-like protected zone can be monitored.

In a further development of the invention, a position of the safe point of interest can be identified by means of the localization system and the distance sensor. The distance sensor here passes the detected raw data or distance data onto the localization system. The localization system processes the raw data or distance data and can, for example, identify the position of the safe point of interest on the basis of a history of detected contour data of the environment and of the environment of the safe point of interest.

In a further development, the localization system has a map model, with the safe points of interest being entered in the map model. The different positions of the safe points of interest are entered in the map model or in an electronic map. The current position and/or location of the movable machine is continuously processed in the localization system on the basis of detected environmental contours and are checked for agreement with a safe point of interest. If an agreement is found, in accordance with a further development of the invention, a position identifier of the safe point of interest is transmitted to the safety controller.

In a further development of the invention, the position of the safe point of interest has at least one respective position identifier. Every safe point of interest is respectively uniquely identified by means of the position identifier. Confusion with another safe point of interest can thereby not occur. The position identifier can be a unique value or an identification, that is an ID, that is stored in a table, for example. The position identifier is, for example, a unique number, for example a continuous number or a unique text. A respective unique value or a position identifier is associated with a position of the safe point of interest via respective accesses to a table. Each position identifier is only present once. The position identifier can, for example, be formed on the basis of the position of the safe point of interest, for example by means of a hash function.

The safety controller then activates a contour recognition function on the contour recognition unit, i.e. an algorithm is activated that detects and identifies a previously stored contour.

In a further development of the invention, the contour of the safe point of interest respectively has at least one contour identifier. Every contour of a safe point of interest is uniquely identified by means of the contour identifier. Confusion with another contour of a safe point of interest can thereby not occur. This contour identifier is reported back to the safety controller. The contour identifier can be a unique value or an identification, that is an ID, that is stored in a table, for example. The contour identifier is, for example, a unique number, for example a continuous number, or a unique text. A respective unique value or a contour identifier is associated with a contour of the safe point of interest via respective accesses to a table. Each contour identifier is only present once. The contour identifier can, for example, be formed on the basis of the contour of the safe point of interest, for example by means of a hash function.

In a further development of the invention, the contour identifier and the position identifier of a safe point of interest are linked via a correlation rule. A correlation rule, for example a table, a software code, or similar, is stored in the software of the safety controller and an association between the position identifier of the localization system and the contour identifier of the contour recognition unit is linked therein. For example, the position identifier of the localization system and the contour identifier of the contour recognition unit are checked in a cross-comparison.

If both part systems deliver a consistent identifier that can be associated with one another, a safe point of interest has been recognized and the safety controller can switch over to another protective measure or safety function. The switching over of the protective measure can comprise, for example, a switching over of protected fields, a size or shape matching of protected fields, and/or a switching over of the properties of a protected field. The properties of a protected field include, for example, the resolution and/or the response time of the protected field. A switching over of the protective measure can also be a safety function such as a force restriction of the drive to which the switchover is made.

If the position identifier of the localization system and of the contour identifier of the contour recognition unit do not agree, the safety system then recognizes an error and changes into the safe state, i.e. the safety system is locked and waits for a reset procedure, for example.

In a further development of the invention, the safety controller sends test vectors to the localization system and/or to the contour recognition unit and receives vectors. Since in accordance with the invention, components can be used that are not safe, not intrinsically safe, or not functionally safe such as the localization system, the laser scanner, the contour recognition unit, etc., in a further development of the invention, they can be diagnosed and tested on a system level by the safety controller to achieve a sufficiently high degree of diagnostic coverage for the safety system.

The safety controller transmits and receives test vectors for this purpose to continuously monitor the system for plausibility and error-free function. The test vectors can, for example, have speed values, orientation values, relative change of position values, and/or reference contours, or the like.

In a further development, the safety system has at least one sensor that is able to measure a movement, a change of position, and/or a speed. The sensor can in particular be an encoder that detects the rotational position of a wheel, with the sensor or encoder being connected to the safety controller. A degree of diagnosis of the system can be further increased by the sensor or encoder.

In a further development of the invention, the safety point of interest has a reflector mark. In addition to the contour identifier, further data such as the signal intensity of a reflector mark can be evaluated, whereby the data obtained have a higher integrity level. A diagnosis capability of the system can be further increased by the reflector mark.

The invention will also be explained in the following with respect to further advantages and features with reference to the enclosed drawing and to embodiments. The Figures of the drawing show in:

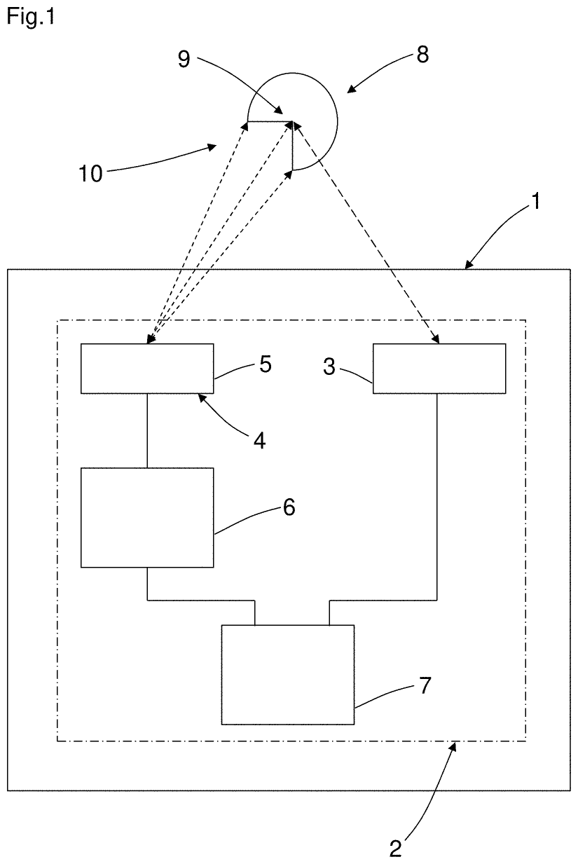

FIGS. 1 to 3 in each case a movable machine having a safety system;

FIGS. 4 to 6 the starting of a transfer station in steps shown schematically after one another with a guideless transport vehicle;

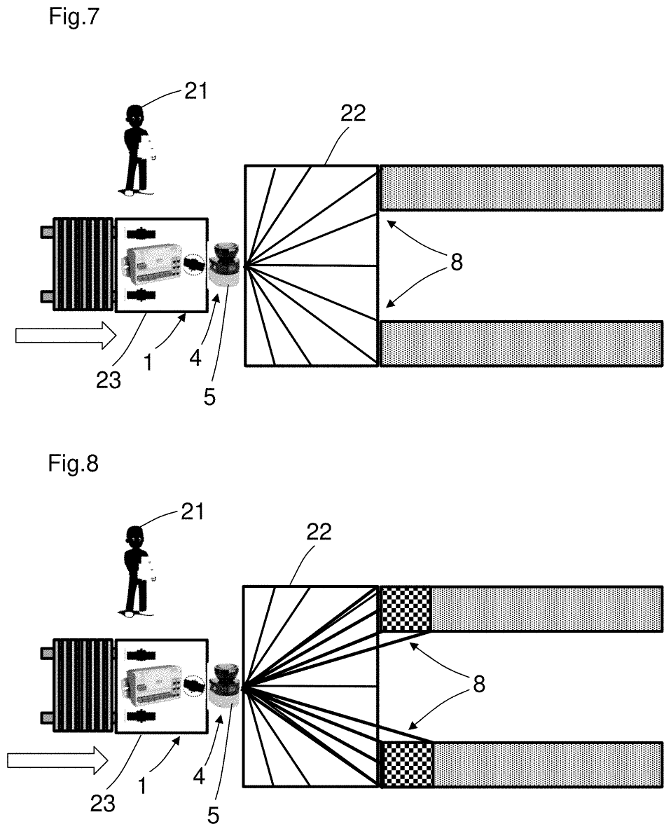

FIGS. 7 to 10 an application for traveling through a constriction in steps shown schematically after one another in time; and

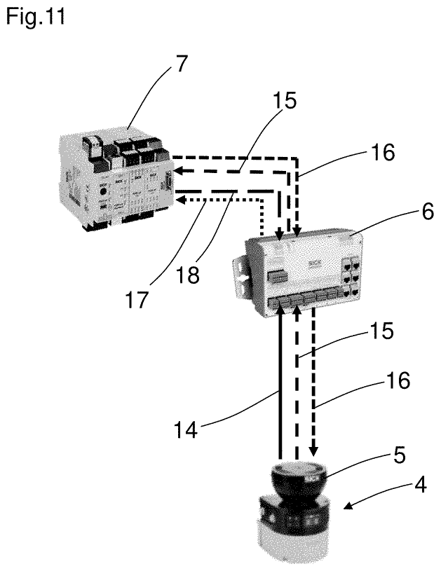

FIG. 11 signal connections between a laser scanner as a distance sensor, a contour recognition unit, and a safety controller.

In the following Figures, identical parts are provided with identical reference numerals.

FIG. 1 shows a movable machine 1 having a safety system 2, having a safety controller 7, having a localization system 3, having a distance sensor 4 for an at least areal monitoring of a monitored zone, and having a contour recognition unit 6, wherein a position 9 of a safe point of interest 8 can be identified by means of the localization system 3 and a contour 10 of the safe point of interest 8 can be identified by means of the distance sensor 4 and the contour recognition unit 6, with a change of the safety function of the safety system 2 taking place by means of the safety controller 7 on an identification of the position 9 of the safe point of interest 8.

The movable machine 1 or the mobile machine can, for example be a guideless vehicle or a transport vehicle, a driverless vehicle or an autonomous vehicle, an automated guided vehicle (AGV), an autonomous mobile robot (AMR), an industrial mobile robot (IMR), or a robot having movable robot arms.

The safe point of interest 8 is a synonymous name for a safe location of interest, that is not a singular point.

In accordance with FIG. 1, the safe point of interest 8 can be uniquely identified by two mutually independent features. These features are the position 9 and the contour 10 or geometry of the safe point of interest 8 or safe location of interest. The safe point of interest 8 is here identified, for example, by a redundant, in particular diverse, safety system 2. The contour of the safe point of interest in accordance with FIG. 1 is an example. Different contours or shapes can be provided.

In accordance with FIG. 1, the distance sensor 4 is a laser scanner 5, a safety laser scanner, a 3D camera, a stereo camera, or a time of flight camera, or similar. To avoid collisions and to protect persons, the laser scanner 5 or the safety laser scanner, for example, monitors a protected field that may not be entered by persons during the movement of the movable machine 1. If the laser scanner 5 recognizes an unauthorized intrusion into the protected field, for instance a leg of a person, the laser scanner 5 triggers an emergency stop of the movable machine 1.

The localization system 3 transmits the position of the movable machine 1 to the safety controller 7. The localization system 3 further transmits test vectors, for example, such as a speed and/or an orientation, to the safety controller 7. The speed can, for example, be determined from positions determined after one another in time.

The contour recognition unit 6 transmits the contours of the environment to the safety controller 7. The contour recognition unit 6 determines the contour from raw data of the distance sensor 4. The contour recognition unit 6 likewise transmits the speed and the orientations of the movable machine 1, for example, to the safety controller 7.

The safety controller 7 thus, for example, receives the speed and the orientation as test vectors from two independent systems. The test vectors can thus be compared with one another and the position data and contour data obtained can be checked for plausibility.

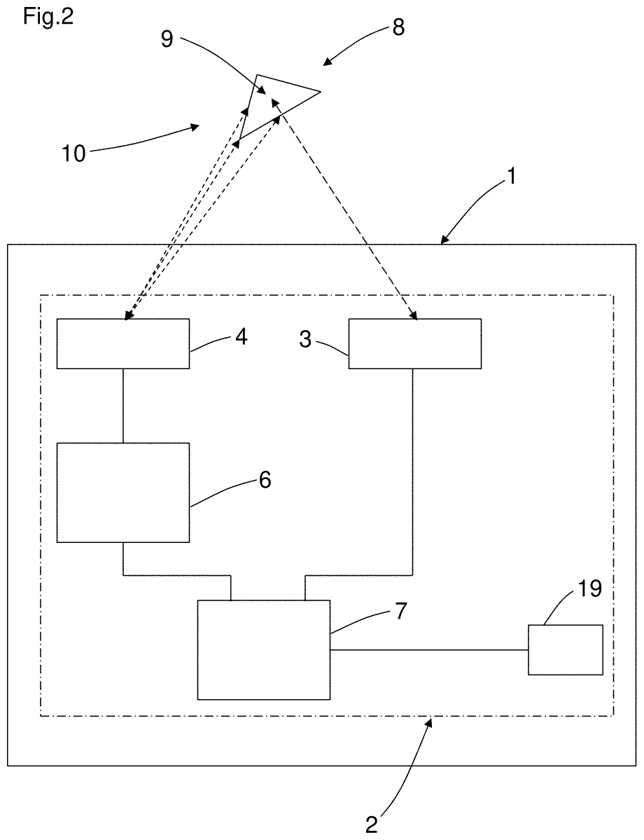

FIG. 2 shows a movable machine 1 having the components in accordance with FIG. 1. In accordance with FIG. 2, the safety system 2 has at least one sensor that is able to measure a movement, a change of position, and/or a speed. The sensor can in particular be an encoder 19 that detects the rotational position of a wheel, with the sensor or encoder 19 being connected to the safety controller 3.

A degree of diagnosis of the system can be further increased by the sensor or encoder 19. The encoder 19 here, for example, delivers the diagnostic information of speed and/or orientation or direction of the movable machine.

In accordance with FIG. 2, the position 9 of the safe point of interest 8 respectively has at least one position identifier. Every safe point of interest 8 is respectively uniquely identified by means of the position identifier. Confusion with another safe point of interest 8 can thereby not occur.

The safety controller 7 then activates a contour recognition function on the contour recognition unit 6, i.e. an algorithm is activated that detects and identifies a previously stored contour.

In accordance with FIG. 2, the contour 10 of a safe point of interest 8 respectively has at least one contour identifier. Every contour 10 of a safe point of interest 8 is respectively uniquely identified by means of the contour identifier. Confusion with another contour 10 of a safe point of interest 8 can thereby not occur. This contour identifier is reported back to the safety controller 7.

In accordance with FIG. 2, the contour identifier and the position identifier of a safe point of interest 8 are linked via a correlation rule. A correlation rule, for example a table, a software code, or similar, is stored in the software of the safety controller 7 and an association between the position identifier of the localization system 3 and the contour identifier of the contour recognition unit is linked therein. For example, the position identifier of the localization system 3 and the contour identifier of the contour recognition unit 6 are checked in a cross-comparison.

If both part systems deliver consistent identifiers that can be associated with one another, a safe point of interest 8 has been recognized and the safety controller 7 can switch to another protective measure or safety function. A switching over of the protective measure can also be a safety function such as a force restriction of the drive to which the switchover is made.

The switching over of the protective measure can comprise, for example, a switching over of protected fields, a size or shape matching of protected fields, and/or a switching over of the properties of a protected field.

The properties of a protected field include, for example, the resolution and/or the response time of the protected field in addition to the shape or size of the protected field.

If the position identifier of the localization system and the contour identifier of the contour recognition unit do not agree, the safety system 2 then recognizes an error and changes into the safe state, i.e. the safety system 2 is locked and waits for a reset procedure, for example.

In accordance with FIG. 2, the safety controller 7 sends test vectors to the localization system 3 and/or to the contour recognition unit 6 and receives vectors.

Since in accordance with the invention components can be used that are not safe, not intrinsically safe, or not functionally safe such as the localization system, the laser scanner 5, the contour recognition unit 6, etc., they can optionally be diagnosed and tested on a system level by the safety controller 7 to achieve a sufficiently high degree of diagnostic coverage for the safety system 2.

The safety controller 7 sends and receives test vectors for this purpose to continuously monitor the system for plausibility and error-free function.

The test vectors can, for example, have speed values, orientation values, relative change of position values, and/or reference contours, or the like.

In accordance with FIG. 2, the safe point of interest 8 can have a reflector mark. In addition to the contour identifier, further data such as the signal intensity of the reflector mark can be evaluated, whereby the data obtained have a higher integrity level. A diagnostic capability of the system can be further increased by the reflector mark.

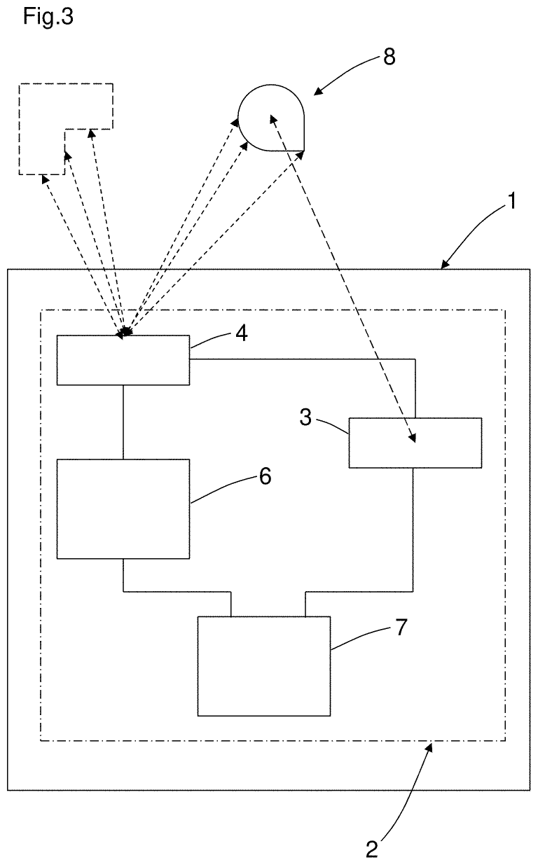

FIG. 3 shows a movable machine 1 having the components in accordance with FIG. 1. In accordance with FIG. 3, the safety system 2 has at least one sensor that is able to measure a movement, a change of position, and/or a speed. The sensor can in particular be an encoder 19 that detects the rotational position of a wheel, with the sensor or encoder 19 being connected to the safety controller 3.

A degree of diagnosis of the system can be further increased by the encoder 19. The encoder 19 here, for example, delivers the diagnostic information speed and/or orientation or direction of the movable machine.

In accordance with FIG. 3, a position 9 of the safe point of interest 8 can be identified by means of the localization system 3 and the distance sensor 4. The distance sensor 4 here passes the detected raw data or distance data onto the localization system 3. The localization system 3 processes the raw data or distance data and can, for example, identify the position 9 of the safe point of interest 8 on the basis of a history of detected contour data of the environment and of the environment of the safe point of interest 8.

In accordance with FIG. 3, the localization system 3 has a map model, with the safe points of interest 8 being entered in the map model.

The different positions 9 of the safe points of interest 8 are entered in the map model or in an electronic map. The current position and/or location of the movable machine 1 is continuously processed in the localization system 3 on the basis of detected environmental contours and are checked for agreement with a safe point of interest 8. If an agreement is found, for example, a position identifier of the safe point of interest 8 is transmitted to the safety controller 7.

The safety controller 7 then activates a contour recognition function on the contour recognition unit 6, i.e. an algorithm is activated that detects and identifies a previously stored contour.

In accordance with FIG. 3, the contour 10 of a safe point of interest 8 respectively has at least one contour identifier. Every contour 10 of a safe point of interest 8 is uniquely identified by means of the contour identifier. Confusion with another contour 10 of a safe point of interest 8 can thereby not occur. This contour identifier is reported back to the safety controller 7.

In accordance with FIG. 3, the contour identifier and the position identifier of a safe point of interest 8 are linked via a correlation rule. A correlation rule, for example a table, a software code, or similar, is stored in the software of the safety controller 7 and an association between the position identifier of the localization system 3 and the contour identifier of the contour recognition unit is linked therein. For example, the position identifier of the localization system 3 and the contour identifier of the contour recognition unit 6 are checked in a cross-comparison.

If both part systems deliver consistent identifiers that can be associated with one another, a safe point of interest 8 has been recognized and the safety controller 7 can switch over to another protective measure or safety function. A switching over of the protective measure can also be a safety function such as a force restriction of the drive to which the switchover is made.

The switching over of the protective measure can comprise, for example, a switching over of protected fields, a size or shape matching of protected fields, and/or a switching over of the properties of a protected field.

The properties of a protected field include, for example, the resolution and/or the response time of the protected field in addition to the shape or size of the protected field.

If the position identifier of the localization system and the contour identifier of the contour recognition unit do not agree, the safety system 2 then recognizes an error and changes into the safe state, i.e. the safety system 2 is locked and waits for a reset procedure, for example.

In accordance with FIG. 3, the safety controller 7 sends test vectors to the localization system 3 and/or to the contour recognition unit 6 and receives vectors.

Since in accordance with the invention, components can be used that are not safe, not intrinsically safe, or not functionally safe such as the localization system, the laser scanner 5, the contour recognition unit 6, etc., they can optionally be diagnosed and tested on a system level by the safety controller 7 to achieve a sufficiently high degree of diagnostic coverage for the safety system 2.

The safety controller 7 transmits and receives test vectors for this purpose to continuously monitor the system for plausibility and error-free function.

The test vectors can, for example, have speed values, orientation values, relative change of position values, and/or reference contours, or the like.

In accordance with FIG. 3, the safe point of interest 8 can have a reflector mark.

In addition to the contour identifier, further data such as the signal intensity of the reflector mark can be evaluated, whereby the data obtained have a higher integrity level. A diagnostic capability of the system can be further increased by the reflector mark.

In accordance with FIG. 3, a position 9 of the safe point of interest 8 can be identified by means of the localization system 3 and the distance sensor 4. The distance sensor 4 here passes the detected raw data or distance data onto the localization system 3. The localization system 3 processes the raw data or distance data and can, for example, identify the position 9 of the safe point of interest 8 on the basis of a history of detected contour data of the environment and of the environment of the safe point of interest 8.

FIG. 4 to FIG. 6 show the starting of a transfer station in steps shown schematically after one another.

The movable machine 1 is formed by a driverless transport vehicle 23 that transports material. The distance sensor 4 is a laser scanner 5 that forms a protected field 22 in front of the transport vehicle 23. The safe point of interest 8 is formed by a first end of a conveying device 20, for example a conveyor belt. The end of the conveyor belt is characterized by a determined contour and a position that the safety system 2 in accordance with FIG. 1, for example, determines. A person 21 is located close to the conveyor belt and should, for example, place the material on the conveyor belt with the finally positioned transport vehicle 23.

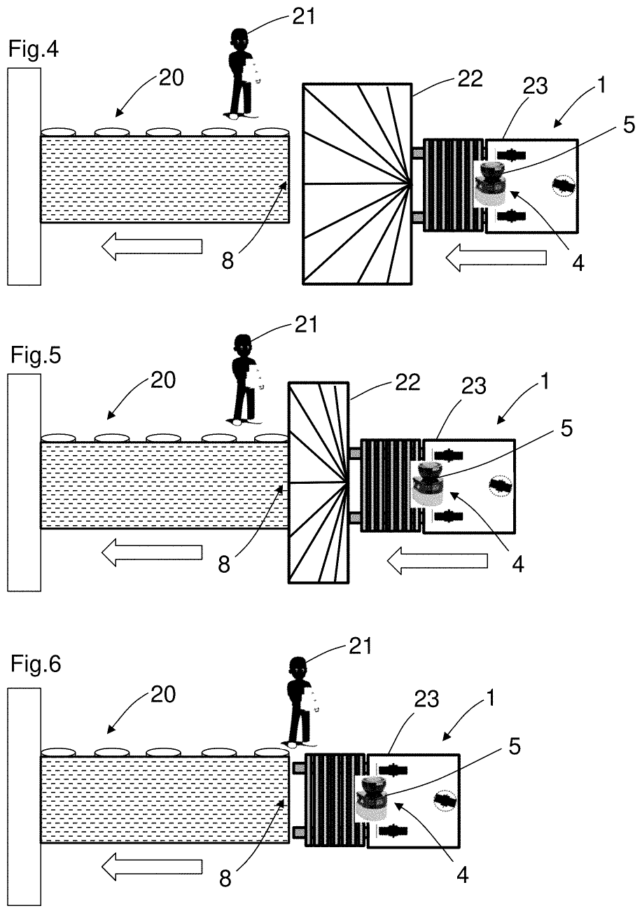

The driverless transport vehicle 23 in accordance with FIG. 4 first moves toward the conveyor belt. In accordance with FIG. 5, the end of the conveyor belt and thus the contour of the conveyor belt end and the position are detected. The safe point of interest 8 is thus identified and the transport vehicle 23 is moved into the destination position in accordance with FIG. 6. The protected field 22 is here, for example, adapted step-wise to the approach of the contour. If the person 21 were detected in the protected field 22, the transport vehicle 23 stops immediately. If the person 21 moves out of the hazard zone or the protected field 22 again, the transport vehicle 23 can continue its movement.

FIG. 7 to FIG. 10 show an application for traveling through a constriction in steps shown schematically after one another in time.

The movable machine 1 is formed by an autonomous transport vehicle 23 that transports material. The distance sensor 4 is a laser scanner 5 that forms a protected field 22 in front of the transport vehicle 23. The safe point of interest 8 is formed by a gateway of the constriction of the passage. The gateway of the constriction is characterized by a determined contour and a position that the safety system 2 in accordance with FIG. 1, for example, determines. A person 21 is located close to the constriction and may not be exposed to any danger.

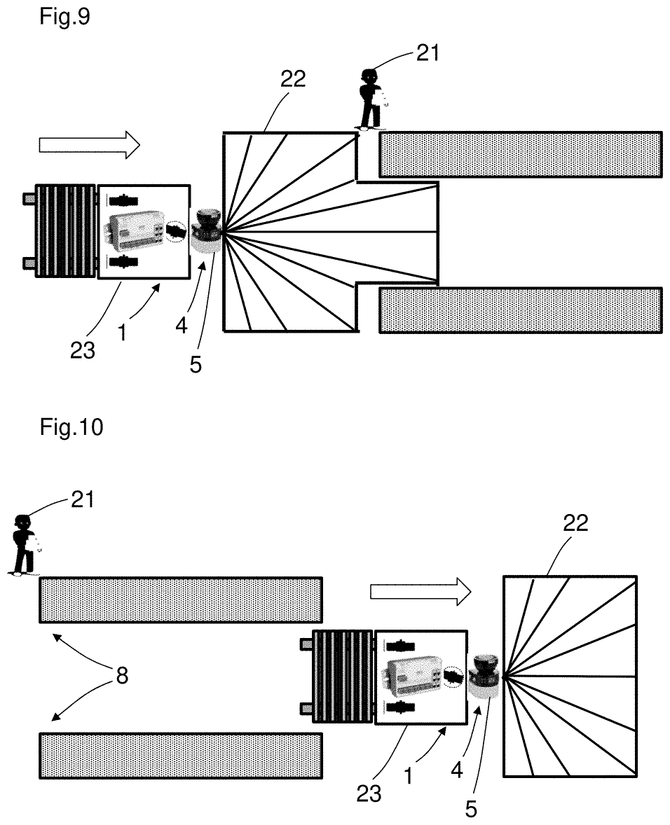

The autonomous transport vehicle 23 in accordance with FIG. 7 first moves toward the constriction. In accordance with FIG. 8, the gateway at the constriction and thus the contour of the gateway and the position are detected. The safe point of interest 8 is thus identified and the transport vehicle is moved further into the passage in accordance with FIG. 9. The protected field 22 is here, for example, adapted step-wise to the approach of the contour. If the person 21 were detected in the protected field 22, the transport vehicle 23 stops immediately. If the person 21 moves out of the hazard zone or the protected field 22 again, the transport vehicle 23 can continue its movement. In accordance with FIG. 10, the transport vehicle has passed through the constriction.

FIG. 11 sows signal connections between a laser scanner 5 as a distance sensor, a contour recognition unit, 6 and a safety controller 7. Raw data 14 or distance data are sent to the contour recognition unit 6 by the laser scanner 5. The laser scanner 5 also checks intrusions into its protected field and forms a shutdown path 15 to the safety controller 7. The laser scanner 5 furthermore includes field sets 16, that is, for example, different protected fields or different protected field configurations by the safety controller 7. The contour recognition unit 6 sends preprocessed results 17 as identifier values to the safety controller 7. For example, a speed identifier, a position identifier, and/or a contour identifier. The safety controller 7 here sends test vectors 18 to the contour recognition unit 6, for example as a response to the identifier values.

### REFERENCE NUMERALS

1 movable machine
2 safety system
3 localization system
4 distance sensor
5 laser scanner
6 contour recognition unit
7 safety controller
8 safe point of interest
9 position of the safe point of interest
10 geometry of the safe point of interest
11 map of the localization system
12 position identifier
13 contour identifier
14 raw data
15 shutdown path
16 field sets
17 preprocessed results
18 test vectors

1. A movable machine, the moveable machine comprising
a safety system,
a safety controller,
a localization system,
a distance sensor for an at least areal monitoring of a monitored zone, and
a contour recognition unit,
wherein a position of a safe point of interest can be identified by means of the localization system;
and a contour of the safe point of interest can be identified by means of the distance sensor and the contour recognition unit,
wherein a change of the safety function of the safety system takes place by means of the safety controller on an identification of the position of the safe point of interest and of the contour of the safe point of interest.

2. The movable machine in accordance with claim 1, wherein the distance sensor is one of a laser scanner, a safety laser scanner, a 3D camera, a stereo camera, and a time of flight camera.

3. The movable machine in accordance with claim 1, wherein a position of the safe point of interest can be identified by means of the location system and the distance sensor.

4. The movable machine in accordance with claim 1, wherein the localization system has one of a map and a map model with the safe point of interest being entered in the map or in the map model.

5. The movable machine in accordance with claim 1, wherein the position of the safe point of interest respectively has at least one position identifier.

6. The movable machine in accordance with claim 1, wherein the contour of a safe point of interest respectively has at least one contour identifier.

7. The movable machine in accordance with claim 1, wherein the contour identifier and the position identifier of a safe point of interest are linked via a correlation rule.

8. The movable machine in accordance with claim 1, wherein the safety controller transmits and receives test vectors to/from the localization system and/or the contour recognition unit.

9. The movable machine in accordance with claim 1, wherein the safety system has at least one sensor that is able to measure at least one of a movement, a change of position, and a speed.

10. The movable machine in accordance with claim 1, wherein the safety system has at least one encoder that detects a rotary position of a wheel, with the encoder being connected to the safety controller.

11. The movable machine in accordance with claim 1, wherein the safe point of interest respectively has a reflector mark.

12. A method having a movable machine, the moveable machine having a safety system, a safety controller, a localization system, a distance sensor for an at least areal monitoring of a monitored zone, and a contour recognition unit,
the method comprising the steps of:
identifying a position of a safe point of interest by means of the localization system;
and identifying a contour of the safe point of interest by means of the distance sensor and the contour recognition unit,
with a change of the safety function of the safety system being carried out by means of the safety controller on an identification of the position of the safe point of interest and of the contour of the safe point of interest.
